(19) United States
(12) Patent Application Publication
(10) Pub. No.: US 2019/0305803 A1
(43) Pub. Date: Oct. 3, 2019

(54) Carrier Aggregation

(71) Applicant: Sequans Communications S.A., Colombes (FR)

(72) Inventor: Thomas Winiecki, Reading (GB)

(21) Appl. No.: 15/942,089

(22) Filed: Mar. 30, 2018

(51) Int. Cl. H04B 1/00; H04B 1/48; H04B 1/30; H04B 1/02

(52) U.S. Cl. CPC H04B 1/0057; H04B 1/0075; H04B 1/0082; H04B 2001/1063; H04B 1/30; H04B 1/02; H04B 1/48

(57) ABSTRACT

A method of transmitting a signal using carrier aggregation, the method comprising providing at least two component carriers, combining the at least two component carriers in the digital domain, converting the combined component carriers to the analog domain with a DAC, passing the combined component carriers through an up conversion mixer to convert each combined component carrier to within a predetermined bandwidth centred on a conversion intermediate frequency to provide a signal for transmission comprising the combined component carriers, transmitting the signal.

### TECHNICAL FIELD

This invention relates to a carrier aggregation transceiver. It is particularly suitable for, but by no means limited to an RF transceiver for LTE and NR systems or more generally, systems in which multiple separate frequency bands are received or transmitted simultaneously.

### BACKGROUND

Most, if not all, LTE transceivers use direct conversion architectures with zero-IF (intermediate frequency) or low-IF frequency. The receiver uses a local oscillator signal at or very near the signal center frequency (carrier frequency) to mix the RF signal to baseband frequencies. The resulting quadrature baseband signal is amplified, filtered and converted to a digital signal. Similarly, the transmitter uses a local oscillator signal to up-convert a baseband quadrature signal onto an RF carrier.

For carrier aggregation in known systems, a separate local oscillator is typically used for each individual channel.

Turning to FIG. 1 as an example of a known system, inter-band carrier aggregation between four FDD (frequency domain duplex) bands is illustrated, for both transmit and receive directions. Out of the four channels (10, 11, 12, 13), two occupy low band frequencies (10 and 11) and two mid band frequencies (12 and 13). Low bands are commonly defined as having frequencies between 617 MHz and 960 MHz. Mid bands fall into a range between 1695 and 2200 MHz and high bands between 2300 and 2690 MHz. Frequency bands between 1427 MHz and 1515 MHz will be discussed separately.

Each transmit path (10A, 11A, 12A, 13A) comprises two IQ-DACs (14) followed by reconstruction filters 15 (to suppress image frequencies). The individual in-phase (I) and quadrature (Q) signals are then scaled with a programmable gain amplifier 17A before they are up converted to an RF carrier frequency using quadrature mixers 16 supplied by an independent local oscillator 16A and further amplified using separate power amplifiers 17.

The transmit signals pass through a quadplexer 18. A quadplexer is an arrangement of four narrow bandpass filters that provides very high isolation between each of the four input/output ports and low insertion loss from and towards the antenna. The use of a quadplexer 18 is representative of similar arrangements used in known systems such as an arrangement of separate filters that are designed to work with one another in a similar manner. For bands further apart in frequency, the antenna 19 signal may be split using a diplexer 19A (as shown between low bands 10, 11 and mid bands 12, 13) and then pass through further duplexers or quadplexers. For TDD (time domain duplex) bands, the arrangement of FIG. 1 would include TX-RX switches and may or may not include TX bandpass filters.

In the receive chain, the signals corresponding to the four receive bands (10B, 11B, 12B, 13B) are filtered separately by relevant filters of the quadplexer 18, amplified using an LNA (20) mixed down to baseband frequency using a down converter mixer 16B supplied by an independent local oscillator signal 21. Each channel is filtered separately (15) and converted to a digital signal with an IQ-ADC (22).

The number of bands that can be aggregated in an inter-band scenario is directly reflected by the number of parallel transmit and receive chains (10, 11, 12, 13) provided by the hardware.

FIG. 1 shows a single antenna 19. If a second antenna is used many building blocks will have to be duplicated (e.g. separate LNAs, down-conversion mixers, IF filters and ADCs). Receivers using four or more antennas require further repetition of the blocks shown as would be understood.

In the case of contiguous intra-band carrier aggregation, a wider band receiver may also be used. For example, when two adjacent 20 MHz channels are combined, single transmit and receive chains may be used with a 40 MHz bandwidth. The local oscillator signal used for up and down conversion is then placed between the component carriers. More than two contiguous channels can be aggregated in the same way. In this mode each component carrier is transmitted and received at the same power level and in the case of LTE, it is assumed that all component carriers originate from the same eNB.

Accordingly, there is a need for improving the architecture of carrier aggregation to reduce or eliminate the duplication of components as in present systems.

### SUMMARY

According to a first aspect there is provided a method of transmitting a signal using carrier aggregation as defined in Claim 1 of the appended claims. Thus there is provided method of transmitting a signal using carrier aggregation, the method comprising providing at least two component carriers, combining the at least two component carriers in the digital domain, converting the combined component carriers to the analog domain with a DAC, passing the combined component carriers through an up conversion mixer to convert each combined component carrier to within a predetermined bandwidth centred on a conversion intermediate frequency to provide a signal for transmission comprising the combined component carriers, transmitting the signal.

Optionally, combining comprises interpolating signals of each component carrier to a sampling rate corresponding to a clock speed of the DAC; and mixing the signals to a combining intermediate frequency.

Optionally, wherein the combining intermediate frequency comprises the difference between a target carrier frequency of the transmitting step and a local oscillator frequency of the up conversion mixer.

Optionally, wherein the component carriers are grouped into frequency band groups, each frequency band group being passed through a dedicated up conversion mixer.

Optionally, wherein the dedicated up conversion mixers use a shared PLL, and wherein each dedicated up conversion mixer may use a different frequency derived from the shared PLL.

Optionally, wherein the component carriers are grouped into frequency band groups and the conversion intermediate frequency is based on the frequency band groups.

Optionally, the component carriers of the signal are split to provide separate signals for front end filtering before transmission.

Optionally, providing at least one notch filter to reject any frequencies associated with any concurrent receiving of a transceiver carrying out the transmitting.

Optionally, where multiple separate frequency band groups are transmitted simultaneously.

According to a second aspect there is provided a method of receiving a signal using carrier aggregation, the method comprising receiving a signal comprising at least two component carriers, combining the component carriers, passing the combined component carriers through a down conversion mixer to convert the combined component carriers to be within a predetermined bandwidth centred on a conversion intermediate frequency, converting the combined component carriers to the digital domain with an ADC, separating the combined component carriers to provide separated component carriers in the digital domain.

Optionally, the second aspect further comprising adjusting the gain of a receiver to maximise SNR of the received signal and minimise noise of the receive chain of the receiver.

Optionally, the second aspect wherein adjusting the gain of the receiver further comprises reducing the gain of the receiver if the total signal at the output of the ADC approaches the full-scale limit of the output by reducing the gain of a receive chain carrying a stronger signal of the received signals, and then reducing the gain of the next strongest signal of the received signal if the first reduction did not reduce the total signal at the output of the ADC.

Optionally, the second aspect wherein the component carriers are grouped into frequency band groups, each frequency band group being passed through a dedicated down conversion mixer.

Optionally, the second aspect wherein the dedicated down conversion mixers use a shared PLL, and wherein each dedicated down conversion mixer may use a different frequency derived from the shared PLL.

Optionally, the second aspect wherein the component carriers are grouped into frequency band groups and the conversion intermediate frequency is based on the frequency band groups.

Optionally, the second aspect wherein separating comprises correcting the combined component carriers for any DC or signal offset caused by signal paths, mixing each component carrier frequency to DC, to form separated component carriers centred around DC.

Optionally, the second aspect further comprising decimating and filtering the separated component carriers after they have been centred around DC.

Optionally, the second aspect further comprising providing at least one notch filter to reject any frequencies associated with any concurrent transmitting by a transceiver carrying out the receiving.

Optionally, the second aspect further comprising receiving multiple separate frequency bands simultaneously.

According to a third aspect there is provided a transceiver arranged to transmit and receive signals using carrier aggregation, the transceiver comprising: a transmit chain comprising a transmit combiner to combine at least two component carriers in the digital domain, a DAC to convert the combined component carriers to the analog domain, a transmit up conversion mixer to convert each combined component carrier to within a predetermined bandwidth centred on a conversion intermediate frequency to provide a signal for transmission comprising the combined component carriers, an antenna for transmitting the signal, wherein the transceiver further comprises a receive chain comprising: the antenna for receiving a signal comprising at least two component carriers, a receive combiner to combine component carriers, a receiver down conversion mixer to convert the combined component carriers to be within a predetermined bandwidth centred on a conversion intermediate frequency, an ADC to convert the combined received signals to the digital domain, a receive separator to separate the combined component carriers to provide separated component carriers in the digital domain.

Optionally, the third aspect further comprising a receiver gain control for adjusting the gain of the receive chain to maximise SNR of the received signal and minimise noise of the receive chain of the transceiver.

Optionally, the third aspect further comprising at least one notch filter to reject any frequencies associated with transmitting in the receive chain and at least one further notch filter to reject any frequencies associated with receiving in the transmit chain.

Optionally, the third aspect further comprising a shared PLL from which local oscillator frequencies are derived for both the up conversion mixer and the down conversion mixer.

With all the aspects, preferable and optional features are defined in the dependent claims.

### BRIEF DESCRIPTION OF THE DRAWINGS

Embodiments will now be described, by way of example only, and with reference to the drawings in which:

FIG. 1 illustrates inter band carrier aggregation in a known system;

FIG. 2 illustrates carrier aggregation according to an embodiment;

FIG. 3 illustrates a separator component of a receive chain;

FIG. 4 illustrates an example of up/down conversion mixer frequency selection;

FIG. 5 illustrates frequency band group collision on the low and high side of an up-down conversion mixer;

FIG. 6 illustrates a receiver gain control strategy; and

FIG. 7 illustrates a notch filter characteristic.

In the figures, like elements are indicated by like reference numerals throughout. Where there are duplicate transmit and receive chains, like elements are often not labelled to increase clarity of the figure.

### OVERVIEW

A benefit of the proposed transceiver scheme is a reduced number of independent signal processing chains for support of carrier aggregation of multiple bands spread across different frequencies. A reduced number of chains allows for reduced silicon area, power consumption and general reduced design, test and validation complexity.

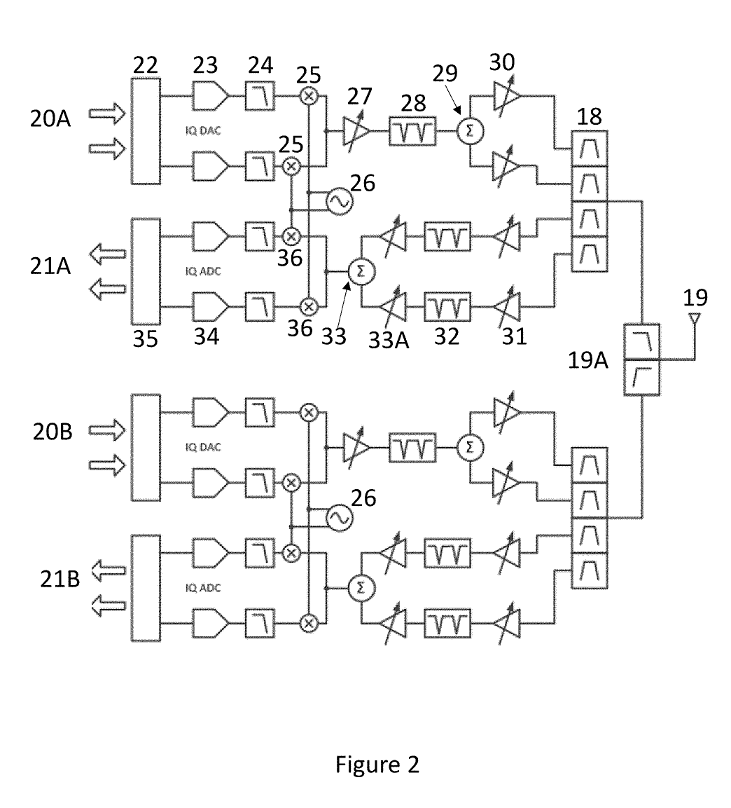

FIG. 2 illustrates a carrier aggregation transceiver in which two frequency bands that are both part of the low band group (20A tx, 21A rx) are aggregated together with two frequency bands that are both part of the mid band group (20B tx, 21B rx). This may be described as CA_LB1-LB2-MB1-MB2. (Low, mid and high band groups are defined in relation to FIG. 4 below).

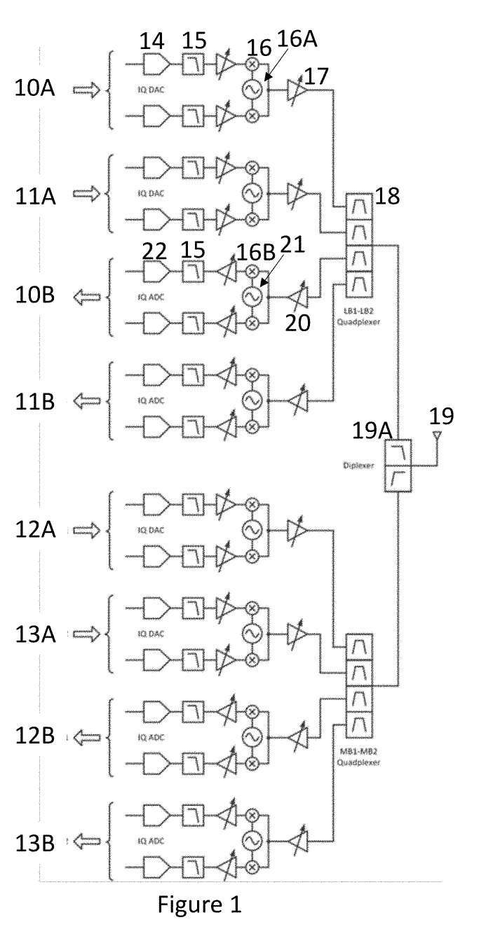

For transmission, carrier aggregation may also be performed between two, three or all four of these bands. For example, two low band component carriers at the digital input 20A may be transmitted at the same time as two further mid-band component carriers generated at input 20B. Their corresponding RF signals are merged by quadplexers 18 and ultimately diplexers 19 into a single composite antenna signal. For the primary antenna only, this would traditionally require 8 frequency generation blocks (8 PLLs), 4 full RX chains and 4 full TX chains as shown in FIG. 1, each including amplifiers, quadrature mixers, baseband amplifiers and filters as well as data converters. With the disclosed new topology, the component count can be reduced to 2 RX chains (20A, 20B) and 2 TX chains (21A, 21B) and 2 PLLs (26) or even a single PLL.

### DETAILED DESCRIPTION

Looking at FIG. 2 in more detail, block 22 of transmit chain 20A comprises a digital signal combiner. The combiner interpolates the signals for transmission that have been grouped together in the relevant component carrier (carrier frequency) band (LB, MB, HB etc depending on implementation) to form combined component carriers. In this example, 20A comprises two low band frequency groups. The interpolation is to a sampling rate corresponding to a suitable resolution to match the clock speed of DAC 23. This may be achieved by using digital finite impulse response (FIR) or infinite impulse response (IIR) filters as would be understood. When interpolating, the phase of each sample can be adjusted in small steps and for each component carrier independently. Each sample is then mixed to an intermediate frequency (a ‘combining’ intermediate frequency) corresponding to the difference of target carrier frequency (of the eventually transmitted signal) and local oscillator frequency 26 so that the target carrier frequency (of the respective transmit band) is achieved after up-conversion with RF mixer 25.

The transmit chains and receive chains will be described separately however, some overlap does occur when discussing similar components or components that are based on variables of the other chain.

The transmit chain 20A also comprises one or more high-speed IQ-DACs (one converter per frequency band group). With a signal frequency of around 400-500MHz nearly all low, mid, and high commercial LTE bands may be transmitted by a DAC operating at at least 1 Gsps, and preferably 2-3 Gsps. The same applies to the IQ-ADCs 34 in receive band 21A.

Anti-aliasing filter 24 maybe used to reject jamming signals at the sampling rate of the DAC 23 (and ADC 34 in the receive chain). The sampling rate is typically 3 to 4 times the maximum recommended signal frequency. The anti-aliasing filters can also remove DAC 23 aliasing images. Preferably, they do not perform any signal shaping and have a flat response for all desired receive and transmit signals.

Transmit chain 20A also comprises an up conversion mixer 25 to convert all component carriers from their combining intermediate frequency to the target carrier frequency using the local oscillator clock. The DACs and ADCs may be those built for NR bands, where the data convertors will have a large bandwidth. For example, NR channels may by up to 100 MHz wide and data convertors are becoming available for processing 4 or 5 adjacent channel simultaneously (400 MHz or 500 MHz signal bandwidth). These relatively new converters can be used for legacy LTE support where, as just mentioned previously, the wide bandwidth allows the processing of LB, MB and HB frequency groupings each by a single ADC/DAC.

As previously discussed, the component carriers are grouped into frequency band groups. Each frequency band group is passed through a dedicated up conversion mixer 25.

One example of implementing the up conversion mixer 25 is selecting the frequency as shown in FIG. 4. Here, when using a frequency (conversion intermediate frequency) of around close to 1125 MHz for the mixer, all low bands of the low band group (617 MHz-960 MHz and 1427-1515 MHz) can be converted to within a predetermined bandwidth of around 500 MHz centred on the conversion intermediate frequency. A second mixer may use twice this conversion intermediate frequency, 2250 MHz to convert all mid bands of the mid band group (1695 MHz-2200 MHz) and high bands of the high band group (2300-2690 MHz) to the same intermediate frequency range. Hence the converter intermediate frequency may be based on the frequency band groups. Because the frequencies of 1125 MHz and 2250 MHz can be easily derived from the same PLL, only one frequency synthesizer is necessary for any number of LB, MB or HB channels and the PLL can even be shared between TX and RX chains in the same transceiver. Furthermore, the frequency of 2250 MHz may also be convenient for clocking the ADCs 34 and DACs 23.

The signal bandwidth of the DAC 23 should be wide enough to resolve the width of the frequency band group each transmit chain is dedicated for. Similarly, the frequency band group targeted in receive chain 21A must be narrow enough so that it can be processed by ADC 34.

To minimize the intermediate bandwidth that DAC 23 and ADC 34 need to process the oscillator frequency 26 may also be selected at the edge of a frequency band group, for example at 960 MHz for low bands. This reduces the intermediate frequency range to 960 MHz-617 MHz=343 MHz. It allows a slower clocking of DAC 23 and ADC 34 and therefore lower current consumption. With this selection of oscillator frequency 26, a separate PLL will be needed to access the mid band frequency band group.

The output of the up conversion mixer is typically buffered and/or scaled by a variable gain amplifier 27.

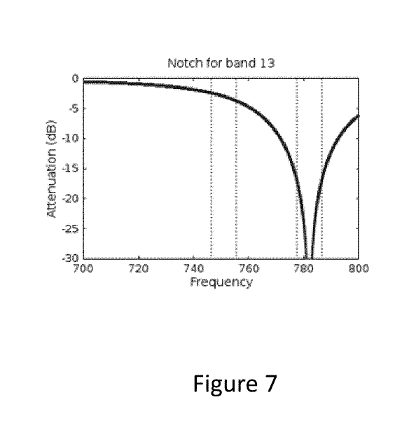

The transmit chain may comprise a notch filter 28. As would be understood, the notch filter directly suppresses a narrow region of the RF spectrum. There are several known techniques to achieve this such as N-path filters using down-sampling mixers to divert signal around the mixer frequency away from the main receive path or so-called Windowed Integrated Samplers (WIS). The effect of a notch filter is illustrated in FIG. 7. As can be seen, frequencies around the targeted region are strongly rejected while nearby frequencies suffer modest attenuation only.

Optionally, in the transmit chain, notch filters are placed at each simultaneously used receive band in the frequency band group at issue. This allows the reduction of DAC 23 quantisation noise below a level where it would desensitise the receiver in an FDD scheme.

The transmit chain 20A may also comprise an RF splitter 29 to split the carriers of the frequency grouping in question ready for transmission. The splitter will introduce 3 dB loss and therefore separate power amplifiers 30 may be used for each band for efficiency. For TDD, no splitter is required and both channels can be amplified using the same power amplifier.

Transmit chain 20B is identical to chain 20A as can be seen from FIG. 2.

Both the transmit chain 20A and receive chain 21A may pass through an element of quadplexer 18 (often referred to as a front-end filter). The purpose of the quadplexer is to remove large out-of-band receive blockers or jammers and for FDD in particular, to isolate the receive chain from the very large transmit signal and transmit chain wide-band noise. The isolation provided is typically insufficient for the remaining leakage signal to be accepted into the ADC. Therefore, additional notch filters (32) may be provided to reduce the receive chain dynamic range further.

Taking the receive chain in reverse, i.e. moving from the antenna 19 towards the separator 35, at the antenna 19, the incoming signal dynamic range may be very large. When receiving, the difference between the smallest detectable signal and the largest wanted signal or blocking signal can be up to 80 dB. For example, with a carrier aggregation scheme, different carriers may arrive at the antenna 19 at different power levels when, in the case of LTE, the eNBs transmitting the signal are located at very different distances from the antenna. Often, this situation exceeds the dynamic range of even the best ADCs which means gain control is preferable before the ADC.

The problem is less severe on the base station (eNB) side as UE gain control aims to equalize the power level of all terminals connected.

Turning to FIG. 6, a receive chain gain control strategy is explained. All signal levels are referred to the reference plane of the ADC 34 input. The minimum gain is determined such that the largest possible desired incoming signal as well as any unwanted blocker after bandpass (quadplexer 18) filtering is sufficiently below the ADC 34 full-scale limit 50. The clipping margin 51 indicated reflects the peak-to-mean power ratio of a modulated input signal being sufficiently below the full-scale limit 50.

At maximum gain the system thermal noise 54 must exceed the ADC quantization noise 55 in order to ensure the ADC does not limit receiver sensitivity. Assuming the dynamic range of the ADC 34 is state-of-the-art, it can be seen that the transmit chain leakage level (TX blocker 52) after an external filter such as quadplexer 18 is too high to be processed by the ADC in maximum receiver gain, i.e. the amplitude of TX blocker 52 swamps any wanted signals 53. It is therefore necessary to selectively suppress the TX leakage blocker 52 so that its power level is similar to that of other out-of-band blockers. This is the purpose of the notch filters 32 in the receive chain that will be described further below.

The proposed strategy for RX gain control is as follows: if possible, receiver gain is increased to maximize signal-to-noise ratio and minimize the receiver noise figure. However, gain must be reduced if the total signal at the ADC output approaches the full-scale limit 50 to avoid clipping. When two receive chains with independent gain control are added together (see RF combiner 33 below) it may not be known known which of the receive chains carries the signal that causes a saturation condition (unless it is one of the wanted receive signals as such a signal would be easily measurable). As a result, it may not be clear which receive chain gain to reduce. When the relevant receive chain signal level rises too high, the gain of the receive chain carrying the stronger of the two signals is typically reduced first as this is less likely to affect performance. If this does not resolve the saturation condition, then the gain of the other receive chain is reduced (additionally or alternatively). This approach can be used in combination with notch filter 32 (suppressing TX leakage blocker 52).

As just mentioned, like transmit chain 20A, receive chain 21A may comprise one or more notch filters 32. The receive chain notch filters are aimed at rejecting frequencies around simultaneously (concurrently) used transmit bands in the frequency band group at issue.

The number of notch filters will typically equal the number of simultaneously supported transmit signals in the frequency band group.

For LTE, each notch filter 32 is tuned to the center of the currently active uplink (transmit) allocation. For a wide allocation (e.g. 50 resource blocks, RB, corresponding to 9 MHz as shown in FIG. 7) the average attenuation is lower but still sufficient. When a narrow allocation is used (e.g. 1 RB or 180 kHz) the deepest part of the notch should be shifted to the narrow allocation to provide sufficient rejection.

The effect of the notch filter is to reduce the transmit leakage signal to roughly the same power level expected for general-out-of-band blocking signals after including external bandpass filter rejection. The overall dynamic range of the receive signal is reduced so that it fits into the dynamic range of the analog-to-digital converter (as discussed in relation to FIG. 6 ADC 34 gain control).

Receive chain 21A also comprises an RF combiner 33. When a combiner is used, noise can be can increased by 3 dB. Optional amplifiers 33A may be tuned to respective bands and reject noise at the image frequency as would be understood in order that the signal combination 33 provides no detrimental effect on noise.

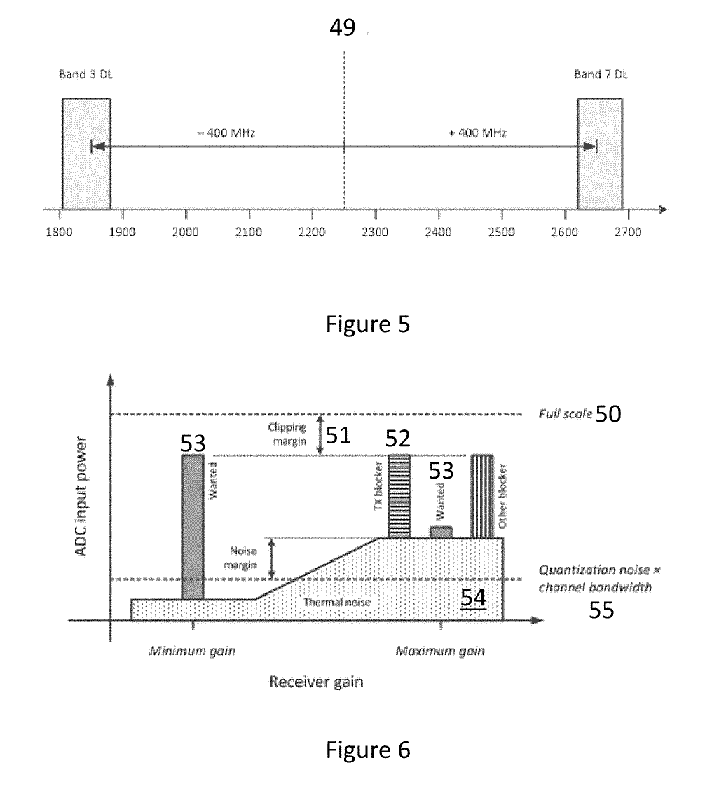

Receive chain 21A also comprises a down conversion mixer 36. The mixer will suffer from image rejection limits. Typically, with digital calibration, a rejection of 35-40 dB is possible. For the receiver, this means frequency band groups on the low- and the high-side of the mixer may potentially collide. This applies to mid and high bands with the frequency bands and groupings of FIG. 4. The collision situation is illustrated in FIG. 5. Here, bands 3 and 7 are around 400 MHz away from the proposed mixer frequency 49. Similar collisions may occur around an 1125 MHz local oscillator signal proposed in FIG. 4. For example, bands 12 and 21 are around 380 MHz to the left and the right of this mixer frequency, respectively. In principle, positive and negative frequencies can be distinguished in the digital domain. However, imperfect image rejection means that high power in one band (which is not filtered by the front-end quadplexers 18) may create images in the other band degrading sensitivity. Therefore, separate receive paths are preferable for mid and high bands that can be tuned to either the low or the high side of the mixer. This also avoids noise at the image frequency from polluting the band in question.

Receive chain 21A also comprises at least one or more high-speed IQ-ADC (one converter per frequency band group). With a signal frequency of around 400-500MHz nearly all low, mid, and high commercial LTE bands may be received.

After the ADC, the digital domain samples are separated 35 to form separated received signals.

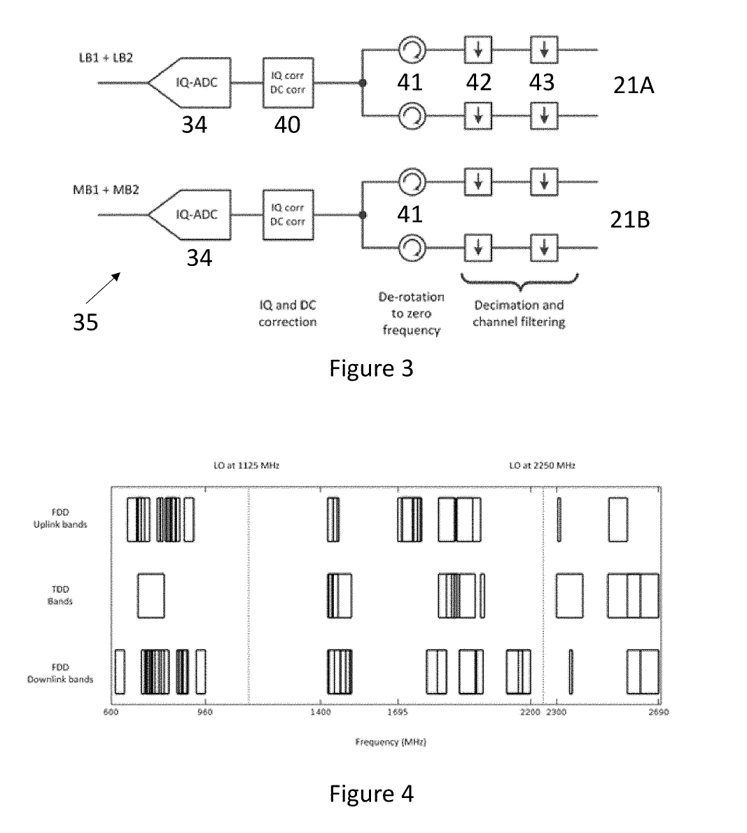

Separation can comprise (see FIG. 3) correcting 40 for any DC or IQ offset caused by imbalances in the I and Q signal paths as would be understood. Then, a digital de-rotator 41 may mix each carrier to zero frequency (DC). For example, if downlink band LB1 has a carrier frequency fC,LB1, then the RF down-conversion mixer 36 shown in FIG. 2 will have translated it to a frequency fC,LB1-fLO, LB. The digital de-rotator multiplies the incoming signal with Exp[−2π j (fC,LB1-fLO, LB)]. At the output (21A), the desired signal will be centered around DC. As discussed, the ADC 34 has a very high sampling rate, in the region of a few hundred MHz. This is much higher than sampling rate required for processing the received signal. Therefore, following de-rotation the signal can be decimated 42 (reduced in sampling rate) and filtered 43, for example using digital FIR filters or IIR filters. At the decimation stage 42, the decimation offset can be selected independently for each downlink signal which allows for accurate timing alignment of the samples as would be understood.

Receive chain 21B is identical to chain 21A as can be seen from FIG. 2.

Multiple transmit and receive chains as described may be part of the same transceiver.

This disclosure has shown how single local oscillators, mixers and signal converters may be used for handling multiple component carriers simultaneously. High-speed and high resolution signal converters may be used which are being developed for NR transceivers, dedicated blocks (notch filters) suppressing unwanted signals in FDD bands may be used as well as gain control strategies.

The carrier aggregation method and transceiver and be utilised in both a UE and a base station (eNB).

Accordingly, an improved carrier aggregation method (tx and rx) is disclosed for both TDD and FDD schemes as well as inter and intra band carrier aggregation.

1. A method of transmitting a signal using carrier aggregation, the method comprising:
providing at least two component carriers;
combining the at least two component carriers in the digital domain;
converting the combined component carriers to the analog domain with a DAC;
passing the combined component carriers through an up conversion mixer to convert each combined component carrier to within a predetermined bandwidth centered on a conversion intermediate frequency to provide a signal for transmission comprising the combined component carriers;
transmitting the signal.

2. The method of claim 1 wherein combining comprises:
interpolating signals of each component carrier to a sampling rate corresponding to a clock speed of the DAC; and mixing the signals to a combining intermediate frequency.

3. The method of claim 2 wherein the combining intermediate frequency comprises the difference between a target carrier frequency of the transmitting step and a local oscillator frequency of the up conversion mixer.

4. The method of claim 1 wherein the component carriers are grouped into frequency band groups, each frequency band group being passed through a dedicated up conversion mixer.

5. The method of claim 4 wherein the dedicated up conversion mixers use a shared PLL, and wherein each dedicated up conversion mixer may use a different frequency derived from the shared PLL.

6. The method of claim 1 wherein the component carriers are grouped into frequency band groups and the conversion intermediate frequency is based on the frequency band groups.

7. The method of claim 1 further comprising splitting the component carriers of the signal to provide separate signals for front end filtering before transmission.

8. The method of claim 1 further comprising providing at least one notch filter to reject any frequencies associated with any concurrent receiving of a transceiver carrying out the transmitting.

9. The method of claim 4 further comprising transmitting multiple separate frequency band groups simultaneously.

10. A method of receiving a signal using carrier aggregation, the method comprising:
receiving a signal comprising at least two component carriers;
combining the component carriers;
passing the combined component carriers through a down conversion mixer to convert the combined component carriers to be within a predetermined bandwidth centered on a conversion intermediate frequency;
converting the combined component carriers to the digital domain with an ADC;
separating the combined component carriers to provide separated component carriers in the digital domain.

11. The method of claim 10 further comprising adjusting the gain of a receiver to maximize SNR of the received signal and minimize noise of the receive chain of the receiver.

12. The method of claim 11 wherein adjusting the gain of the receiver further comprises reducing the gain of the receiver if the total signal at the output of the ADC approaches the full-scale limit of the output by reducing the gain of a receive chain carrying a stronger signal of the received signals; and then reducing the gain of the next strongest signal of the received signal if the first reduction did not reduce the total signal at the output of the ADC.

13. The method of claim 10 wherein the component carriers are grouped into frequency band groups, each frequency band group being passed through a dedicated down conversion mixer.

14. The method of claim 13 wherein the dedicated down conversion mixers use a shared PLL, and wherein each dedicated down conversion mixer may use a different frequency derived from the shared PLL.

15. The method of claim 10 wherein the component carriers are grouped into frequency band groups and the conversion intermediate frequency is based on the frequency band groups

16. The method of claim 10 wherein separating comprises correcting the combined component carriers for any DC or signal offset caused by signal paths, mixing each component carrier frequency to DC, to form separated component carriers centered around DC.

17. The method of claim 16 further comprising decimating and filtering the separated component carriers after they have been centered around DC.

18. The method of claim 10 further comprising providing at least one notch filter to reject any frequencies associated with any concurrent transmitting by a transceiver carrying out the receiving.

19. The method of claim 13 further comprising receiving multiple separate frequency bands simultaneously.

20. A transceiver arranged to transmit and receive signals using carrier aggregation, the transceiver comprising:
a transmit chain comprising:
a transmit combiner to combine at least two component carriers in the digital domain;
a DAC to convert the combined component carriers to the analog domain;
a transmit up conversion mixer to convert each combined component carrier to within a predetermined bandwidth centered on a conversion intermediate frequency to provide a signal for transmission comprising the combined component carriers;
an antenna for transmitting the signal;
wherein the transceiver further comprises a receive chain comprising:
the antenna for receiving a signal comprising at least two component carriers;
a receive combiner to combine component carriers;
a receiver down conversion mixer to convert the combined component carriers to be within a predetermined bandwidth centered on a conversion intermediate frequency;
an ADC to convert the combined received signals to the digital domain;
a receive separator to separate the combined component carriers to provide separated component carriers in the digital domain.

21. The transceiver of claims 20 further comprising a receiver gain control for adjusting the gain of the receive chain to maximize SNR of the received signal and minimize noise of the receive chain of the transceiver.

22. The transceiver of claim 20 further comprising at least one notch filter to reject any frequencies associated with transmitting in the receive chain and at least one further notch filter to reject any frequencies associated with receiving in the transmit chain.

23. The transceiver of claim 20 further comprising a shared PLL from which local oscillator frequencies are derived for both the up conversion mixer and the down conversion mixer.
